(19) United States
(12) Patent Application Publication
(10) Pub. No.: US 2026/0228227 A1
(43) Pub. Date: Aug. 6, 2026

(54) FEEDBACK DRIVEN VECTOR DATA STORAGE-BASED QUERY MANAGEMENT SYSTEM

(71) Applicant: CenturyLink Intellectual Property LLC, Denver, CO (US)

(72) Inventors: Sampath Bukya, Siddipet (IN); Hemmy Hanzas Sebastianappan, Bengaluru (IN)

(73) Assignee: CenturyLink Intellectual Property LLC, Denver, CO (US)

(21) Appl. No.: 19/416,810

(22) Filed: Dec. 11, 2025

Related U.S. Application Data
(60) Provisional application No. 63/753,554, filed on Feb. 4, 2025.

(51) Int. Cl. G06F 16/2457; G06F 16/22; G06F 16/248

(52) U.S. Cl. CPC G06F 16/2457; G06F 16/2237; G06F 16/248

(57) ABSTRACT

Novel tools and techniques are provided for implementing feedback driven vector data storage-based query management system. In examples, after receiving, from a requesting device, a request for information regarding an issue with a network service being provisioned at a premises location, a computing system generates and sends a prompt for a large language model ("LLM") to query a vector data storage device for the information from a knowledge database. After receiving an output from the LLM, the computing system may determine a content of the output from the LLM, which is generated by the LLM based on knowledge base data that has been retrieved, divided, and vectorized by the vector data storage device. If the information has been found, the computing system presents the content of the output. If the output has not been found, the computing system generates an incident report that initiates an investigation into the issue.

### CROSS-REFERENCE TO RELATED APPLICATIONS

This application claims the benefit of U.S. Provisional Application No. 63/753,554, filed February 4, 2025, entitled "Feedback Driven Vector Data Storage-Based Query Management System," which is incorporated herein by reference in its entirety.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to methods, systems, and apparatuses for implementing a feedback driven vector data storage-based query management system.

### BACKGROUND

For addressing issues that arise when provisioning network services, potential solutions may be based on rote information that has been compiled by some technical group of the service provider provisioning the network services and/or may be based on an agent's personal experience with handling such issues. In either case, the solutions are either incomplete, not always up-to-date, and/or dependent on experience level of agents of the service provider. Such potential solutions are generally not tailored or customized to particular customers receiving the network services. It is with respect to this general technical environment to which aspects of the present disclosure are directed.

### BRIEF DESCRIPTION OF THE DRAWINGS

A further understanding of the nature and advantages of particular embodiments may be realized by reference to the remaining portions of the specification and the drawings, which are incorporated in and constitute a part of this disclosure.

FIG. 1 depicts an example system for implementing a feedback driven vector data storage-based query management system, in accordance with various embodiments.

FIG. 2A depicts an example sequence flow for implementing the feedback driven vector data storage-based query management system, in accordance with various embodiments.

FIG. 2B depicts another example sequence flow for implementing the feedback driven vector data storage-based query management system, in accordance with various embodiments.

FIG. 3 depicts an example user interface that may be used when implementing the feedback driven vector data storage-based query management system, in accordance with various embodiments.

FIGS. 4A-4C depict flow diagrams illustrating an example method for implementing the feedback driven vector data storage-based query management system, in accordance with various embodiments.

FIGS. 5A-5C depict flow diagrams illustrating another example method for implementing the feedback driven vector data storage-based query management system, in accordance with various embodiments.

FIG. 6 depicts a block diagram illustrating an exemplary computer or system hardware architecture, in accordance with various embodiments.

### DETAILED DESCRIPTION OF CERTAIN EMBODIMENTS

### Overview

The present technology provides for a feedback driven vector data storage-based query management system. In examples, in response to receiving, from a requesting device, a first request for information regarding a first issue associated with a first network service that is provisioned, by a service provider, at a premises location, a computing system may generate a first prompt for a large language model ("LLM") to query a vector data storage device (e.g., a retrieval augmented generation ("RAG") data storage system) for the information (e.g., a knowledge base) regarding the first issue from a set of databases (e.g., a knowledge database). The computing system may send the first prompt to the LLM. In response to receiving an output from the LLM, the computing system may determine a content of the output from the LLM, which is generated by the LLM based on knowledge base data, which has been accessed from the set of databases, that has been retrieved, divided, and vectorized by the vector data storage device. If the output indicates that the information has been found, the computing system may present the content of the output. If the output indicates that the information has not been found, the computing system may generate a first incident report that initiates a first investigation into the first issue in response to receiving the first message, and may generate and present a message to the requesting device indicating that the first issue is being investigated.

In examples, the feedback driven vector data storage-based query management system may include an advanced customer support system that features an AI system that employs a RAG framework that dynamically accesses, processes, and updates the knowledge base to optimize issue resolution efficiency. In examples, the knowledge base may encompass documented resolution processes and annotations from previously closed incidents associated with previous issues with network services. Utilizing specific RAG techniques, the AI system may generate customized solutions to user or customer inquiries, thereby minimizing dependence on individual agent expertise and proactively addressing potential future incidents.

The capability of the AI system to learn and adapt from historical data, in conjunction with agent training documents and user interactions, etc., enhances its effectiveness over time. Key metrics for success of the advanced customer support system may include reduced resolution times, increased customer satisfaction, and decreased incident volume. For handling complex or ambiguous queries, mechanisms are integrated that receive and incorporate feedback from users, alongside continuous enhancements to the capabilities of the AI system. The advanced customer support system may address the challenges of traditional customer support by delivering efficient, automated solutions to a broad spectrum of customer issues. The AI system may utilize the dynamic knowledge base, updated with new data from incidents and real-time agent solutions. When integrated with customer relationship management ("CRM") systems, the AI system may generate highly customized solutions based on specific customer inquiries and historical data. Additionally, the AI system may employ reinforcement learning to refine its decision-making and adaptability, and may use predictive analytics to anticipate potential issues, enabling proactive resolution or human agent alerts.

These and other aspects of the feedback driven vector data storage-based query management system are described in greater detail with respect to the figures.

The following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

In this detailed description, wherever possible, the same reference numbers are used in the drawing and the detailed description to refer to the same or similar elements. In some instances, a sub-label is associated with a reference numeral to denote one of multiple similar components. When reference is made to a reference numeral without specification to an existing sub-label, it is intended to refer to all such multiple similar components. In some cases, for denoting a plurality of components, the suffixes "a" through "n" may be used, where n denotes any suitable non-negative integer number (unless it denotes the number 14, if there are components with reference numerals having suffixes "a" through "m" preceding the component with the reference numeral having a suffix "n"), and may be either the same or different from the suffix "n" for other components in the same or different figures. For example, for component #1 X05a-X05n, the integer value of n in X05n may be the same or different from the integer value of n in X10n for component #2 X10a-X10n, and so on. In other cases, other suffixes (e.g., s, t, u, v, w, x, y, and/or z) may similarly denote non-negative integer numbers that (together with n or other like suffixes) may be either all the same as each other, all different from each other, or some combination of same and different (e.g., one set of two or more having the same values with the others having different values, a plurality of sets of two or more having the same value with the others having different values, etc.).

Unless otherwise indicated, all numbers used herein to express quantities, dimensions, and so forth used should be understood as being modified in all instances by the term "about." In this application, the use of the singular includes the plural unless specifically stated otherwise, and use of the terms "and" and "or" means "and/or" unless otherwise indicated. Moreover, the use of the term "including," as well as other forms, such as "includes" and "included," should be considered non-exclusive. Also, terms such as "element" or "component" encompass both elements and components including one unit and elements and components that include more than one unit, unless specifically stated otherwise.

Aspects of the present invention, for example, are described below with reference to block diagrams and/or operational illustrations of methods, systems, and computer program products according to aspects of the invention. The functions and/or acts noted in the blocks may occur out of the order as shown in any flowchart. For example, two blocks shown in succession may in fact be executed substantially concurrently or the blocks may sometimes be executed in the reverse order, depending upon the functionalities and/or acts involved. Further, as used herein and in the claims, the phrase "at least one of element A, element B, or element C" (or any suitable number of elements) is intended to convey any of: element A, element B, element C, elements A and B, elements A and C, elements B and C, and/or elements A, B, and C (and so on).

The description and illustration of one or more aspects provided in this application are not intended to limit or restrict the scope of the invention as claimed in any way. The aspects, examples, and details provided in this application are considered sufficient to convey possession and enable others to make and use the best mode of the claimed invention. The claimed invention should not be construed as being limited to any aspect, example, or detail provided in this application. Regardless of whether shown and described in combination or separately, the various features (both structural and methodological) are intended to be selectively rearranged, included, or omitted to produce an example or embodiment with a particular set of features. Having been provided with the description and illustration of the present application, one skilled in the art may envision variations, modifications, and alternate aspects, examples, and/or similar embodiments falling within the spirit of the broader aspects of the general inventive concept embodied in this application that do not depart from the broader scope of the claimed invention.

In an aspect, the technology relates to a method, including receiving, by a computing system and from a requesting device, a first request for information regarding a first issue associated with a first network service that is provisioned, by a service provider, at a premises location; generating, by the computing system, a first prompt for an LLM to query a vector data storage device for the information regarding the first issue from a set of databases; sending, by the computing system, the first prompt to the LLM; receiving, by the computing system, an output from the LLM; determining, by the computing system, a content of the output from the LLM; based on a determination that the output from the LLM includes a first output including data associated with the first issue, presenting, by the computing system, the first output to the requesting device, the first output being generated by the LLM based on knowledge base data, which has been accessed from the set of databases, that has been retrieved, divided, and vectorized by the vector data storage device; and based on a determination that the output from the LLM includes a first message indicating that the vector data storage device was unable to find data associated with the first issue within the set of databases, performing the following: generating, by the computing system, a first incident report that initiates a first investigation into the first issue in response to receiving the first message; and generating and presenting, by the computing system, a second message to the requesting device, the second message indicating that the first issue is being investigated.

In another aspect, the technology relates to a system, including a processing system and memory coupled to the processing system. The memory includes computer executable instructions that, when executed by the processing system, causes the system to perform operations including: receiving, from a requesting device, a first request for information regarding a first issue associated with a first network service that is provisioned, by a service provider, at a premises location; generating a first prompt for an LLM to query a vector data storage device for the information regarding the first issue from a set of databases; sending the first prompt to the LLM; receiving an output from the LLM; determining a content of the output from the LLM; based on a determination that the output from the LLM includes a first output including data associated with the first issue, presenting the first output to the requesting device, the first output being generated by the LLM based on knowledge base data, which has been accessed from the set of databases, that has been retrieved, divided, and vectorized by the vector data storage device; and based on a determination that the output from the LLM includes a first message indicating that the vector data storage device was unable to find data associated with the first issue within the set of databases, performing the following: generating a first incident report that initiates a first investigation into the first issue in response to receiving the first message; and generating and presenting a second message to the requesting device, the second message indicating that the first issue is being investigated.

In yet another aspect, the technology relates to a method, including concurrent with or prior to receiving a first input from a requesting device via a first user interface ("UI"), predicting, by a computing system, one or more topics of interest to a first end-user associated with a premises location at which a first network service is being provisioned; presenting, by the computing system, the one or more topics of interest to the requesting device via the first UI; generating, by the computing system, one or more prompts for an LLM to query a vector data storage device, based on the one or more topics; receiving, by the computing system and from the requesting device via the first UI, a selection of a first topic of interest among the one or more topics of interest; sending, by the computing system, a first prompt among the one or more prompts to the LLM, the first prompt corresponding to the first topic of interest; receiving, by the computing system, an output from the LLM; determining, by the computing system, a content of the output from the LLM; based on a determination that the output from the LLM includes a first output including data associated with the first topic of interest, presenting, by the computing system, the first output to the requesting device, the first output being generated by the LLM based on knowledge base data, which has been accessed from a set of databases, that has been retrieved, divided, and vectorized by the vector data storage device; and based on a determination that the output from the LLM includes a first message indicating that the vector data storage device was unable to find data associated with the first topic of interest within the set of databases, performing the following: generating, by the computing system, a first incident report that initiates a first investigation into the first topic of interest in response to receiving the first message; and generating and presenting, by the computing system, a second message to the requesting device, the second message indicating that the first topic of interest is being investigated.

Various modifications and additions can be made to the embodiments discussed herein without departing from the scope of the invention. For example, while the embodiments described above refer to particular features, the scope of this invention also includes embodiments having different combinations of features and embodiments that do not include all of the above-described features.

### Specific Exemplary Embodiments

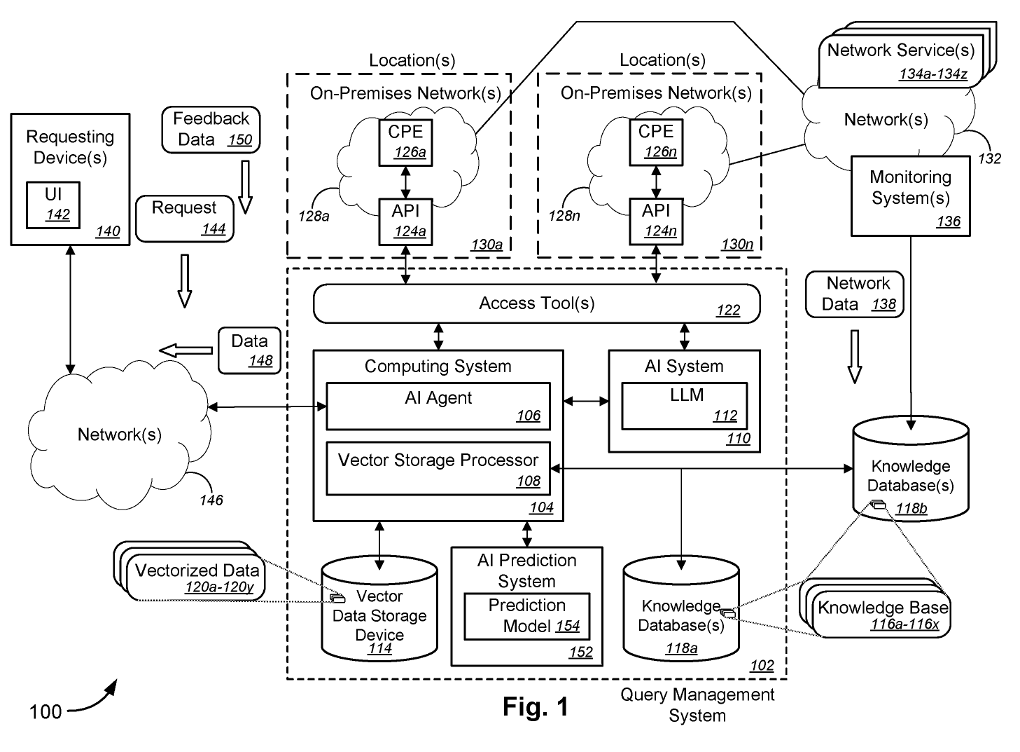

Turning to the embodiments as illustrated by the drawings, FIGS. 1-5 illustrate some of the features of methods, systems, and apparatuses for implementing feedback driven vector data storage-based query management system, as referred to above. The methods, systems, and apparatuses illustrated by FIGS. 1-5 refer to examples of different embodiments that include various components and steps, which can be considered alternatives or which can be used in conjunction with one another in the various embodiments. The description of the illustrated methods, systems, and apparatuses shown in FIGS. 1-5 is provided for purposes of illustration and should not be considered to limit the scope of the different embodiments.

With reference to the figures, FIG. 1 depicts an example system 100 for implementing feedback driven vector data storage-based query management system, in accordance with various embodiments.

In the non-limiting example of FIG. 1, system 100 includes a query management system 102, which may include a computing system 104, which may include an artificial intelligence ("AI") agent 106 and/or a vector storage processor 108. In some examples, the computing system 104 may include at least one of a system orchestrator, a server, a cloud computing system, or a distributed computing system, and/or the like. System 100 may further include AI system 110, which may be based on an LLM 112. AI system 110 may also train the LLM 112, and may use the LLM 112 for inferencing tasks. In examples, the LLM 112 is either a private LLM or a public LLM. In the embodiments described below, unless otherwise indicated, the LLM 112 is a private LLM. As used herein, a private LLM refers to an LLM that is trained on specific, carefully vetted datasets that are controlled to avoid dubious, unreliable, or false information, whereas a public LLM refers to an LLM that is trained based on datasets obtained from the Internet. Security and reliability can be better controlled with a private LLM compared with a public LLM. In some examples, the LLM 112 includes a private instance of a publicly accessible generative AI model (e.g., a private instance of Generative Pre-trained Transformer ("GPT"), such as GPT-4, or the like).

System 100 may further include a vector data storage device 114 (also referred to herein as an "embeddings vector storage device" or the like). In examples, the vector data storage device 114 may include a RAG data storage system that is a long-term, persisting, cache-like vector database. In some examples, in response to receiving a query for information from the vector data storage device 114, the vector storage processor 108 may retrieve knowledge base data 116, from among knowledge base data 116a-116x that is stored in knowledge database(s) 118a or 118b, based on the query. The vector storage processor 108 divides the knowledge base data 116 into smaller sized portions, then vectorizes each portion, with the vectorized portions (which are also referred to as "embeddings") each being of a size that the LLM 112 can process. The vectorized portions are stored in the vector data storage device 114 as part of a plurality of vectorized data 120a-120y (collectively, "vectorized data 120" or "embeddings 120" or the like). System 100 may further include one or more access tools 122, which may include interfaces, connectors, etc.

As used herein, an embedding refers to, or corresponds to, a vector representation of data (such as objects like images, documents, audio clips, video clips, software code, etc.) in a multiple-dimensional vector space. In examples, such data includes textual data, message data, image data, audio data, video data, document data, and/or data files (e.g., JavaScript Object Notation ("JSON") files, which are open standard file format files and data interchange format files that use human-readable text to store and transmit data objects consisting of attribute-value pairs and arrays). Similar or closely related/relevant objects, when in vector representation, are proximate to each other in the vector space (i.e., within a threshold distance in vector space), while different or unrelated/non-relevant objects, when in vector representation, are farther apart from each other in the vector space (i.e., beyond the threshold distance in vector space). In this way, embeddings may be used to enable machine learning models to find similar objects. For instance, given a photograph or a document, a machine learning model that uses embeddings could find a similar photograph or document, because embeddings make it possible for computers to understand the relationships between words or other objects, thus making embeddings a foundational aspect of AI systems.

System 100 may further include a plurality of application programming interfaces ("APIs") 124a-124n (collectively, "APIs 124" or the like) and a plurality of customer premises equipment ("CPE") 126a-126n (collectively, "CPE 126" or the like). The plurality of CPE 126 is each accessible by the computing system 104 and/or by the AI system 110, via the one or more access tools 122 and via a corresponding one of the plurality of APIs 124a-124n, the plurality of CPE 126 being located within a corresponding plurality of on-premises networks 128a-128n, which is located at a corresponding plurality of locations 130a-130n. System 100 may further include a network(s) 132 and a plurality of network services 134a-134z (collectively, "network services 134" or the like) that are provided via network equipment in the network(s) 132. The plurality of network services 134 are provisioned at the plurality of locations 130a-130n, which is associated with one or more entities among a plurality of entities. In some examples, network services 134 are provisioned to the plurality of CPE 126a-126n in the on-premises networks 128a-128n at the plurality of locations 130a-130n. Herein, n, x, y, and z are non-negative integer numbers that may be either all the same as each other, all different from each other, or some combination of same and different (e.g., one set of two or more having the same values with the others having different values, a plurality of sets of two or more having the same value with the others having different values, etc.). In some examples, the plurality of network services 134 may be monitored by monitoring system(s) 136. Network data 138 that is collected by monitoring system(s) 136 is stored in knowledge database(s) 118a or 118b, and any changes to one or more network services among the plurality of network services 134, as reflected in changes in network data 138, may be used to update corresponding vectorized data 120a-120y.

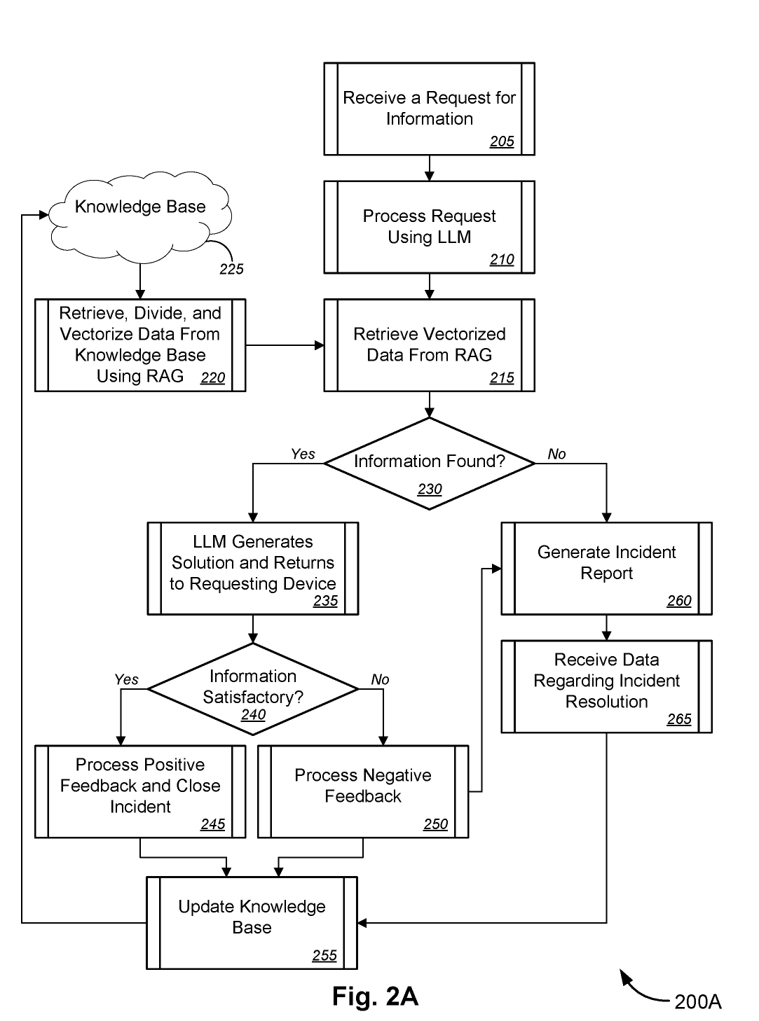

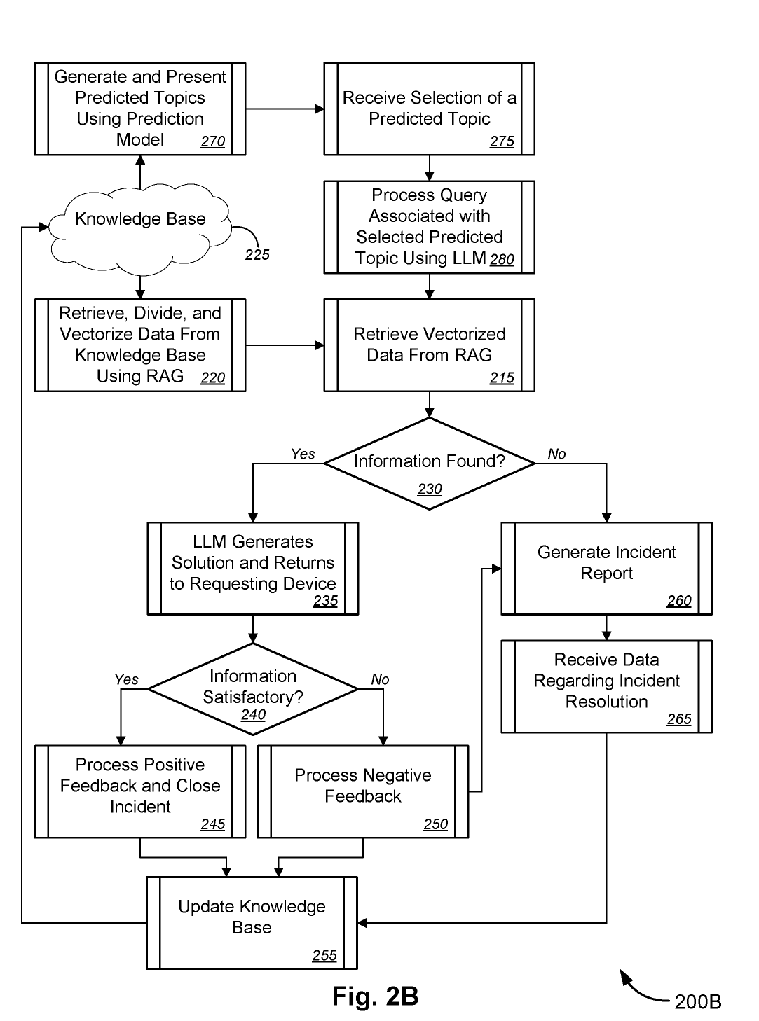

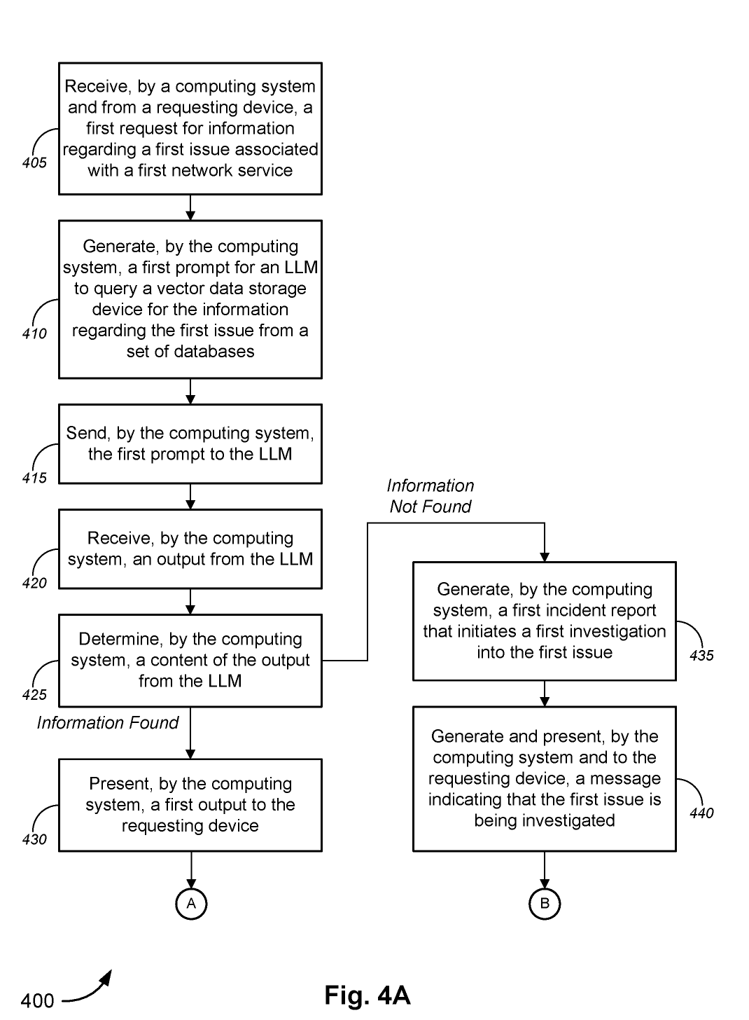

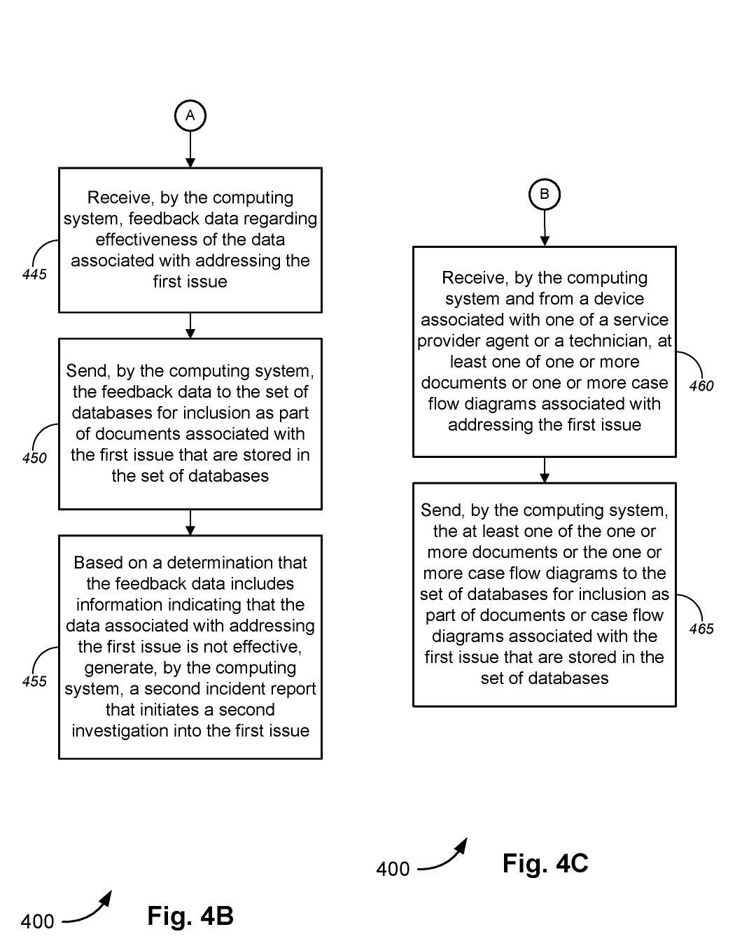

System 100 may further include a requesting device(s) 140, which, via a UI 142, enables sending of a request 144 for data associated with one of the plurality of network services 134a-134z to computing system 104 (in some cases, to AI agent 106), via network(s) 146. In response to receiving the request 144, computing system 104 may return data 148 via network(s) 146, in some cases, following the processes and operations as described in detail below (such as in FIGS. 2A and 4A-4C below). In some examples, the requesting device(s) 140 may send feedback data 150 to the computing system 104 in response to the data 148 to indicate whether the data 148 is satisfactory or effective in terms of addressing issues with the network services. The knowledge base data 116 stored in the knowledge database(s) 118a or 118b may be updated with both positive and negative feedback. In response to receiving any negative feedback, the computing system 104 may cause an incident report (or ticket) to be generated, which may trigger events that result in the service provider sending one or more technicians or other personnel to investigate the issue to reach an incident resolution, the results of which may also be used to update the knowledge base data 116.

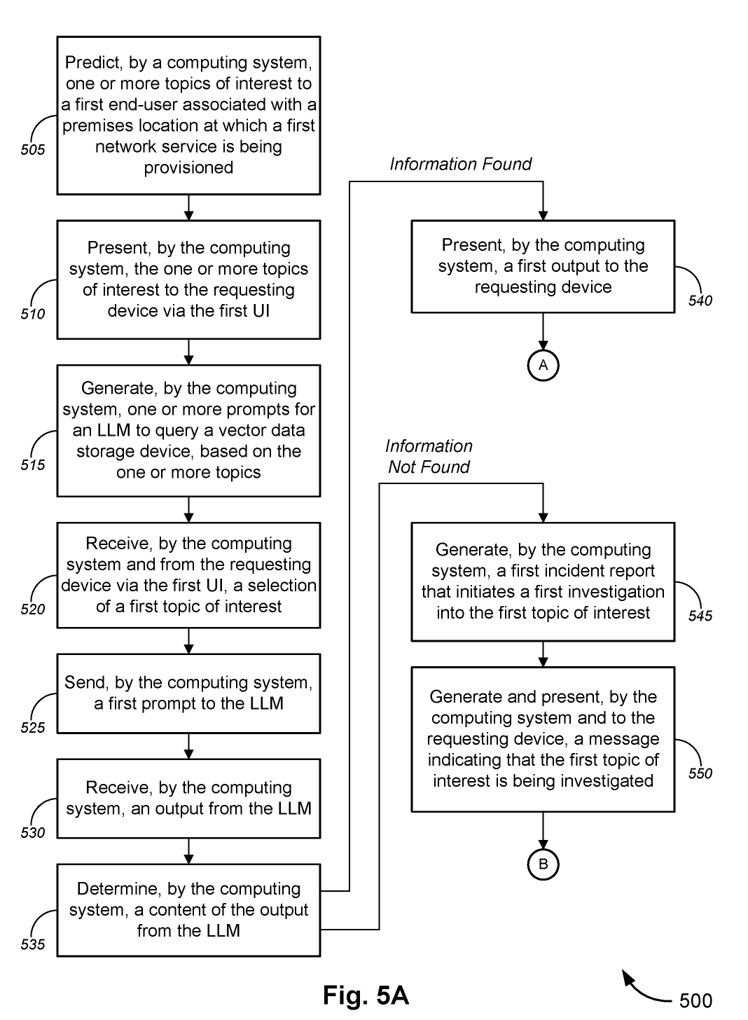

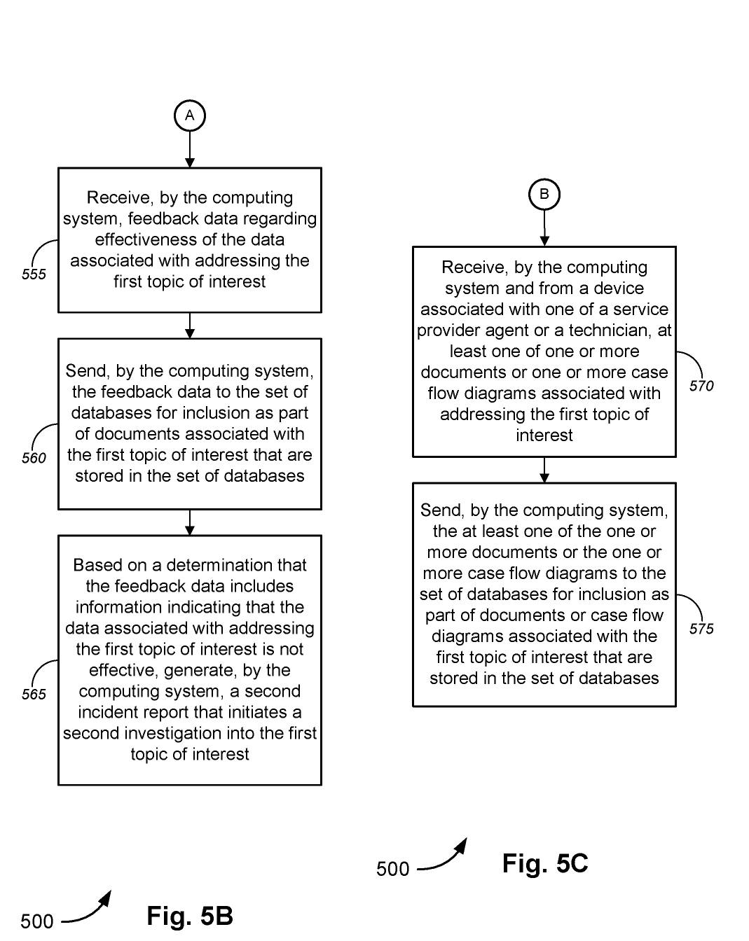

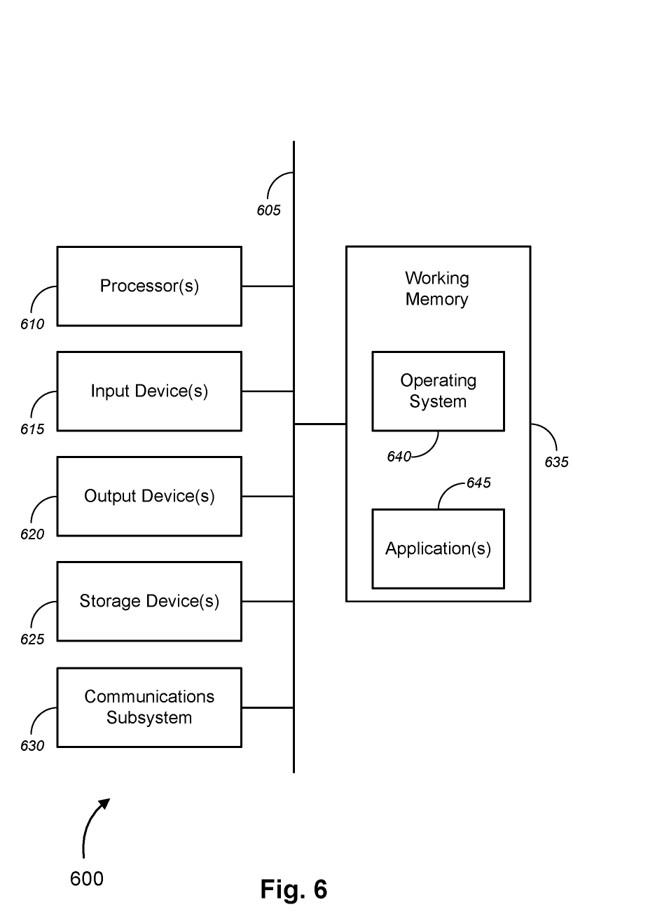

In examples, the system 100 may further include an AI prediction system 152 that uses a prediction model 154 to predict potential issues or topics of interest, based on one or more of the knowledge base data 116 being (or previously) retrieved or accessed from the knowledge database 118a or 118b, vectorized data 120 being (or previously) retrieved or accessed from the vector data storage device 114, queries being (or previously) sent to the computing system 104, the AI agent 106, or the AI system 110, the user who is sending the request via the requesting device(s) 140, and/or similar network services 134 being provisioned to other premises locations associated with other users/entities (particularly in a similar geographic location to the premises location associated with the user), and/or the like. The computing system 104 may present or display the predicted potential issues or topics of interest via the UI 142. In response to receiving a selection of one of the predicted potential issues or topics of interest, from the requesting device(s) 140 via the UI 142, in the form of another request 144, the computing system 104 may return data 148 via network(s) 146, in some cases, following the processes and operations as described in detail below (such as in FIGS. 2B and 5A-5C below). Feedback data 150 may be similarly processed as described above.

In some instances, the requesting device(s) 140 may each include, but is not limited to, one of a desktop computer, a laptop computer, a tablet computer, a smart phone, a mobile phone, or a network operations center ("NOC") computing system or console, and/or the like. In some cases, the requesting device(s) 140 is associated with a user, who may include one of an agent of a service provider provisioning the network services 134, a technician who is working to resolve the first issue, or an end-user associated with one of the premises locations 130a-130n at which one of the network services 134 is being provisioned. In some cases, the agent of the service provider may include one of a customer care management team, a billing team member, or a service delivery team member, and/or the like. In some instances, the end-user may include one of an individual, a group of individuals, a private company, a group of private companies, a public company, a group of public companies, an institution, a group of institutions, an association, a group of associations, a governmental agency, a group of governmental agencies, or any suitable entity or their agent(s), representative(s), owner(s), and/or stakeholder(s), or the like. In some examples, the premises locations 130a-130n may include, but is not limited to, one of a residential customer premises, a business customer premises, a corporate customer premises, an enterprise customer premises, an education facility customer premises, a medical facility customer premises, or a governmental customer premises, and/or the like.

According to some embodiments, unless otherwise indicated, networks 128a-128n, 132, and 146 may each include, without limitation, one of a local area network ("LAN"), including, without limitation, a fiber network, an Ethernet network, a Token-Ring^{TM} network, and/or the like; a wide-area network ("WAN"); a wireless wide area network ("WWAN"); a virtual network, such as a virtual private network ("VPN"); the Internet; an intranet; an extranet; a public switched telephone network ("PSTN"); an infra-red network; a wireless network, including, without limitation, a network operating under any of the IEEE 802.11 suite of protocols, the Bluetooth™ protocol known in the art, and/or any other wireless protocol; and/or any combination of these and/or other networks. In a particular embodiment, the networks 128a-128n, 132, and 146 may include an access network of the service provider (e.g., an Internet service provider ("ISP")). In another embodiment, the networks 128a-128n, 132, and 146 may include a core network of the service provider and/or the Internet.

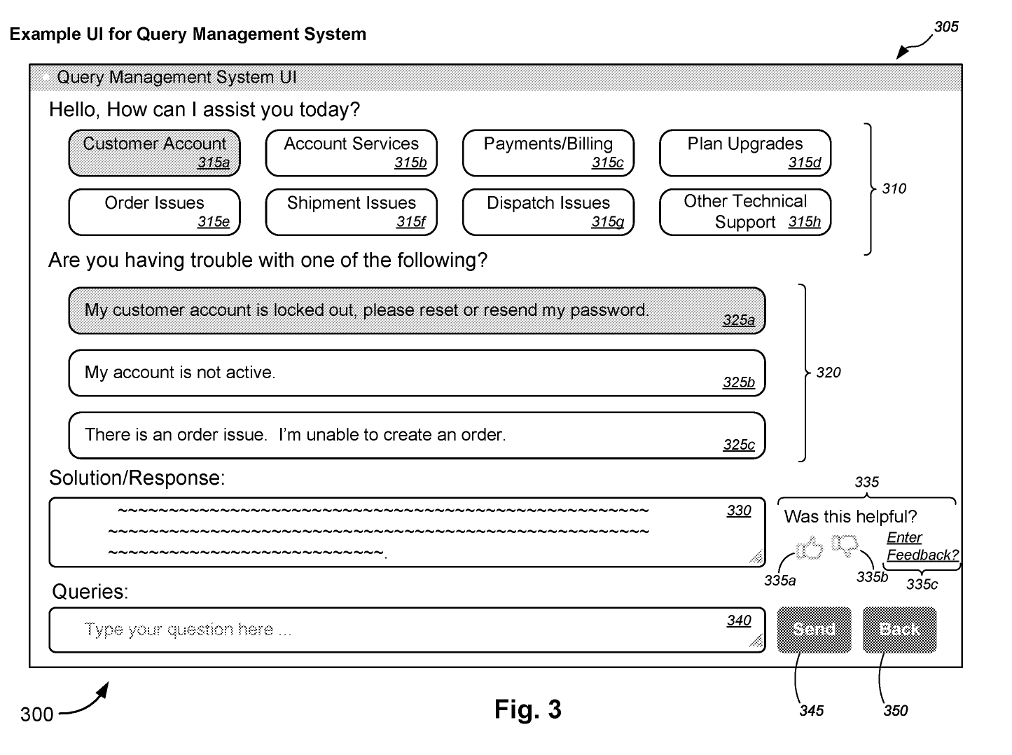

In operation, query management system 102, computing system 104, AI system 110, and/or AI prediction system 152 may perform methods for implementing feedback driven vector data storage-based query management system, as described in detail with respect to FIGS. 2A-5C. For example, example sequence flows 200A and 200B as described below with respect to FIGS. 2A and 2B, example UI 300 for a query management system as described below with respect to FIG. 3, and example methods 400 and 500 as described below with respect to FIGS. 4A-4C and 5A-5C may be applied with respect to the operations of system 100 of FIG. 1.

FIG. 2A depicts an example sequence flow 200A for implementing feedback driven vector data storage-based query management system, in accordance with various embodiments. FIG. 2B depicts another example sequence flow 200B for implementing feedback driven vector data storage-based query management system, in accordance with various embodiments.

Referring to the example sequence flow 200A of FIG. 2A, at operation 205, a query management system and/or a computing system (e.g., query management system 102 or computing system 104 of FIG. 1, or the like) may receive a request for information from a requesting device (e.g., requesting device(s) 140 of FIG. 1, or the like), in some cases, via a UI (e.g., UI 142 of FIG. 1, or the like). In some examples, the request for information includes a request (e.g., request 144 of FIG. 1, or the like) for information regarding a first issue associated with a first network service (e.g., one of network services 134a-134z of FIG. 1, or the like) that is provisioned, by a service provider, at a premises location (e.g., one of locations 130a-130n of FIG. 1, or the like). At operation 210, the query management system and/or the computing system may process the request, in some cases, using an LLM (e.g., LLM 112 of AI system 110 of FIG. 1, or the like). At operation 215, the query management system and/or the computing system may retrieve vectorized data (e.g., vectorized data 120 among vectorized data 120a-120y of FIG. 1, or the like) from a RAG (e.g., vector data storage device 114 of FIG. 1, or the like). At operation 220, the RAG retrieves, divides, and vectorizes data from a knowledge base 225 (e.g., knowledge database(s) 118a and/or 118b of FIG. 1, or the like).

At operation 230, the query management system and/or the computing system may determine whether information has been found in response to the request. If information is found, then the example sequence flow 200A may continue onto the process at operation 235. If information is not found, then the example sequence flow 200A may continue onto the process at operation 260. At operation 235, the LLM generates a solution response and returns the solution response to the requesting device, via the query management system and/or the computing system and via the UI (in the case that the request is received via the UI). At operation 240, the query management system and/or the computing system receives feedback from one or more users regarding whether the information is satisfactory in terms of addressing the request (e.g., addressing an issue associated with a network service (e.g., one of network services 134a-134z of FIG. 1, or the like) that is provisioned, by a service provider, at a premises location (e.g., one of locations 130a-130n of FIG. 1, or the like)). If information is indicated as being satisfactory, then the example sequence flow 200A may continue onto the process at operation 245. If information is indicated as not being satisfactory, then the example sequence flow 200A may continue onto the process at operation 250.

At operation 245, based on a determination that the feedback data includes information indicating that the data associated with addressing the issue is satisfactory or effective (e.g., positive feedback), the query management system and/or the computing system may process the positive feedback, and causes the incident associated with the issue to be closed within the query management system. The example sequence flow 200A may continue onto the process at operation 255, where the knowledge base is updated with the positive feedback.

At operation 250, based on a determination that the feedback data includes information indicating that the data associated with addressing the first issue is not satisfactory or effective (e.g., negative feedback), the query management system and/or the computing system may process the negative feedback. The example sequence flow 200A may continue onto the process at operation 255, where the knowledge base is updated with the negative feedback. The example sequence flow 200A may also continue onto the process at operation 260.

At operation 260, the query management system and/or the computing system may generate an incident report that initiates an investigation into the issue. At operation 265, the query management system and/or the computing system may receive data regarding incident resolution, after the incident associated with the issue has been resolved. The example sequence flow 200A may continue onto the process at operation 255, where the knowledge base is updated with the data regarding incident resolution.

With reference to the example sequence flow 200B of FIG. 2B, at operation 270, the query management system and/or the computing system may generate and present predicted topics of interest, using a prediction model (e.g., an prediction model 154 of the AI prediction system 152 of FIG. 1, or the like), based on data retrieved or accessed from the knowledge base 225. At operation 275, the query management system and/or the computing system may receive a selection of a predicted topic of interest among the presented predicted topics of interest. At operation 280, the query management system and/or the computing system may process a query associated with the selected predicted topic of interest, using the LLM. The processes at operations 220-265 of the example sequence flow 200A of FIG. 2A may be repeated for processing the query of operation 280 for example sequence flow 200B of FIG. 2B.

FIG. 3 depicts an example UI 300 that may be used when implementing feedback driven vector data storage-based query management system, in accordance with various embodiments.

In the example UI 300 of FIG. 3, a query management system UI 305 of a query management system (e.g., query management system 102 of FIG. 1, or the like) may include a main topic selection portion 310. The main topic selection portion 310 may include options for a plurality of main topics including one or more of customer account 315a, account services 315b, payments or billing 315c, plan upgrades 315d, order issues 315e, shipment issues 315f, dispatch issues 315g, and/or other technical support 315h, and/or the like. In some examples, the query management system UI 305 may further include a topic prediction portion 320 that displays options for selecting one or more predicted topics of interest that are predicted based on a prediction model (e.g., an prediction model 154 of the AI prediction system 152 of FIG. 1, or the like). In an example, assuming an option for customer account 315a has been selected (as depicted in FIG. 3 by a gray colored field/button for customer account 315a), the one or more predicted topics of interest may include a first through third predicted topics 325a-325c, where the first predicted topic 325a includes "My customer account is locked out, please reset or resend my password," the second predicted topic 325b includes "My account is not active," and the third predicted topic 325c includes "There is an order issue. I'm unable to create an order."

The query management system UI 305 may further include a solution or response portion or field 330 that displays or presents an output of an LLM (e.g., LLM 112 of AI system 110 of FIG. 1, or the like) that processes, summarizes, and generates an output that addresses the selected or indicated issues, based on vectorized data that has been accessed or retrieved from a vector data storage device (e.g., vector data storage device 114 of FIG. 1, or the like). The vector data storage device (which may include a RAG) retrieves, divides, and vectorizes knowledge base information from a set of databases (e.g., knowledge database(s) 118a and/or 118b of FIG. 1, or the like).

In examples, the query management system UI 305 may further include a feedback portion 335 that may include a positive feedback icon 335a, a negative feedback icon 335b, and a feedback entry link 335c. The positive feedback icon 335a, when selected, may send positive feedback data (e.g., feedback data 150 of FIG. 1) to the query management system, while the negative feedback icon 335b, when selected, may send negative feedback data (e.g., feedback data 150 of FIG. 1) to the query management system. The feedback entry link 335c, when selected, may open an entry field (either by opening an entry window or navigating to a feedback webpage, or the like) that provides a user with options to enter written feedback. In some examples, the query management system UI 305 may further include a query portion 340 that provides the user with options to enter a question or query. The query portion 340 may further include a send button 345 that, when selected or depressed, sends the question or query that is entered in the query portion 340 to the query management system. The query management system UI 305 may further include a back button 350 that, when selected or depressed, either resets the context or displays the main topics to the user.

In various aspects, with reference to FIGS. 1-3, the present technology may be directed to an advanced customer support system engineered to optimize issue resolution efficiency. The advanced customer support system (e.g., query management system 102 of FIG. 1, or the like) may feature an AI-powered bot (e.g., AI system 110, AI agent 106, and/or AI prediction system 152 of FIG. 1, or the like) employing a RAG framework (e.g., using vector storage processor 108 and vector data storage device 114 of FIG. 1, or the like) to dynamically access, process, and update a knowledge base (e.g., vectorized data 120 among vectorized data 120a-120y and/or underlying knowledge base data 116 that has been accessed from knowledge database(s) 118a and/or 118b of FIG. 1, or the like). In examples, the knowledge base may encompass documented resolution processes and annotations from previously closed incidents. Utilizing specific RAG techniques, the AI-powered bot may generate customized solutions to user or customer inquiries, thereby minimizing dependence on individual agent expertise and proactively addressing potential future incidents.

The capability of the AI-powered bot to learn and adapt from historical data, in conjunction with agent training documents and user interactions, etc., enhances its effectiveness over time. Key metrics for success of the advanced customer support system may include reduced resolution times, increased customer satisfaction, and decreased incident volume. For handling complex or ambiguous queries, mechanisms are integrated that receive and incorporate feedback from users, alongside continuous enhancements to the capabilities of the AI-powered bot. The advanced customer support system may address the challenges of traditional customer support by delivering efficient, automated solutions to a broad spectrum of customer issues. The AI-powered bot may utilize the dynamic knowledge base, updated with new data from incidents and real-time agent solutions. When integrated with CRM systems, the AI-powered bot may generate highly customized solutions based on specific customer inquiries and historical data. Additionally, the AI-powered bot may employ reinforcement learning to refine its decision-making and adaptability, and may use predictive analytics to anticipate potential issues, enabling proactive resolution or human agent alerts.

FIGS. 4A-4C (collectively, "FIG. 4") depict flow diagrams illustrating an example method 400 for implementing feedback driven vector data storage-based query management system, in accordance with various embodiments. With reference to FIGS. 4A-4C, the operations of example method 400 may be performed by a computing system of a query management system (e.g., computing system 104 of query management system 102 of FIG. 1, or the like). Method 400 of FIG. 4A either continues onto FIG. 4B following the circular marker denoted, "A," or continues onto FIG. 4C following the circular marker denoted, "C."

In the example method 400 of FIG. 4A, at operation 405, a computing system may receive, from a requesting device (e.g., requesting device(s) 140 of FIG. 1, or the like), a first request (e.g., request 144 of FIG. 1, or the like) for information regarding a first issue associated with a first network service (e.g., one of network services 134a-134z of FIG. 1, or the like) that is provisioned, by a service provider, at a premises location (e.g., one of locations 130a-130n of FIG. 1, or the like). In some examples, the requesting device may be associated with one of an agent of the service provider, a technician who is working to resolve the first issue, or a first end-user associated with the premises location at which the first network service is being provisioned. At operation 410, the computing system may generate a first prompt for an LLM (e.g., LLM 112 of AI system 110 of FIG. 1, or the like) to query a vector data storage device (e.g., vector data storage device 114 of FIG. 1, or the like) for the information regarding the first issue from a set of databases (e.g., knowledge database(s) 118a and/or 118b of FIG. 1, or the like). In examples, generating the first prompt for the LLM to query the vector data storage device (at operation 410) may include generating a second prompt for the LLM to query an index table for the vector data storage device for at least one of a first index reference associated with the first network service or a second index reference associated with the first issue. At operation 415, the computing system may send the first prompt to the LLM. At operation 420, the computing system may receive an output from the LLM. At operation 425, the computing system may determine a content of the output from the LLM. If information is found, then method 400 may continue onto the process at operation 430. If information is not found, then method 400 may continue onto the process at operation 435.

In some examples, the set of databases may contain a plurality of documents, a plurality of case flow diagrams, a plurality of queries, a plurality of websites, or data collected by a CRM system, and/or the like. In some cases, the plurality of documents may be associated with a plurality of network services provisioned by the service provider. In some instances, the plurality of documents may include one or more documents associated with addressing one or more network issues associated with one or more of the plurality of network services. In some examples, the plurality of case flow diagrams may each be associated with addressing a network issue among a plurality of network issues. In examples, the plurality of queries may include queries associated with network services, queries associated with network issues associated with network services, and queries associated with addressing the network issues, and/or the like. In some cases, the plurality of websites may include websites associated with network services, websites associated with network issues associated with network services, and websites associated with addressing the network issues, and/or the like. In some instances, the data collected by the CRM system may include customer data associated with a plurality of customers of the service provider, service data associated with network services provisioned to the plurality of customers, and billing data associated with billing for the network services provisioned to the plurality of customers, and/or the like.

In examples, the vector data storage device may include a RAG data storage system that is a long-term, persisting, cache-like vector database. In some cases, the knowledge base data may include vector representations of portions of textual data, message data, image data, audio data, video data, document data, or data files associated with the first network service that are contained in at least one of the plurality of documents, the plurality of case flow diagrams, the plurality of queries, the plurality of websites, or the data collected by the CRM system, and that are divided based on one or more of sentences, paragraphs, pages, documents, subject, topic, or relevance to the first network service.

At operation 430, based on a determination that the output from the LLM includes a first output including data associated with the first issue, the computing system may present the first output (e.g., data 148 of FIG. 1, or the like) to the requesting device. In examples, the first output is generated by the LLM based on knowledge base data (e.g., vectorized data 120 among vectorized data 120a-120y of FIG. 1, or the like), which has been accessed from the set of databases, that has been retrieved, divided, and vectorized by the vector data storage device. In some cases, the first output may include a summary of data associated with addressing the first issue. Method 400 may continue onto the process at operation 445 in FIG. 4B, following the circular marker denoted, "A."

At operation 435, based on a determination that the output from the LLM includes a first message indicating that the vector data storage device was unable to find data associated with the first issue within the set of databases, the computing system may generate a first incident report that initiates a first investigation into the first issue, in response to receiving the first message. At operation 440, the computing system may generate and present a second message (e.g., data 148 of FIG. 1, or the like) to the requesting device, the second message indicating that the first issue is being investigated. Method 400 may continue onto the process at operation 460 in FIG. 4C, following the circular marker denoted, "B."

In examples, receiving the first request (at operation 405) and presenting the first output (at operation 430) or the second message (at operation 440) may be implemented using at least one of a UI (e.g., UI 142 of FIG. 1, or the like), a portal, a software application, or an API (e.g., one of APIs 124a-124n of FIG. 1, or the like).

At operation 445 in FIG. 4B (following the circular marker denoted, "A," in FIG. 4A), method 400 may include the computing system receiving feedback data regarding effectiveness of the data associated with addressing the first issue. At operation 450, the computing system may send the feedback data (e.g., feedback data 150 of FIG. 1, or the like) to the set of databases for inclusion as part of documents associated with the first issue that are stored in the set of databases. At operation 455, based on a determination that the feedback data includes information indicating that the data associated with addressing the first issue is not effective, the computing system may generate a second incident report that initiates a second investigation into the first issue.

At operation 460 in FIG. 4C (following the circular marker denoted, "B," in FIG. 4B), method 400 may include the computing system receiving, from a device associated with one of a service provider agent or a technician, at least one of one or more documents or one or more case flow diagrams associated with addressing the first issue. In some examples, each document or case flow diagram may include information regarding effectiveness in terms of resolving the first issue. At operation 465, the computing system may send the at least one of the one or more documents or the one or more case flow diagrams to the set of databases for inclusion as part of documents or case flow diagrams associated with the first issue that are stored in the set of databases.

In some examples, the first request is received via a first UI (e.g., UI 142 of FIG. 1, or the like). In examples, prior to or as the first request is being entered via the first UI, the computing system may predict one or more topics of interest to the first end-user associated with the premises location at which the first network service is being provisioned. The computing system may present the one or more topics of interest to the requesting device via the first UI, and may generate one or more prompts for the LLM to query the vector data storage device, based on the one or more topics of interest. In some examples, the one or more topics of interest may be predicted using a predictive AI model (e.g., an prediction model 154 of the AI prediction system 152 of FIG. 1, or the like) based on at least one of a first ID associated with the first end-user, a second ID associated with the premises location, a third ID associated with the first network service, a history of requests from the first end-user, a history of queries from the first end-user, a history of complaints from the first end-user, current incident reports associated with a geographical location within which the premises location is located, historical incident reports associated with the geographical location within which the premises location is located, current incident reports associated with a type of network service corresponding to the first network service, historical incident reports associated with the type of network service corresponding to the first network service, current incident reports associated with a type of network equipment used for provisioning the first network service, historical incident reports associated with the type of network equipment used for provisioning the first network service, or a history of service requests associated with one or more of the first ID, the second ID, or the third ID, and/or the like.

FIGS. 5A-5C (collectively, "FIG. 5") depict flow diagrams illustrating another example method 500 for implementing feedback driven vector data storage-based query management system, in accordance with various embodiments. Referring to FIGS. 5A-5C, the operations of example method 500 may be performed by a computing system of a query management system (e.g., computing system 104 of query management system 102 of FIG. 1, or the like). Method 500 of FIG. 5A either continues onto FIG. 5B following the circular marker denoted, "A," or continues onto FIG. 5C following the circular marker denoted, "C."

In the example method 500 of FIG. 5A, at operation 505, a computing system may predict one or more topics of interest to a first end-user associated with a premises location (e.g., one of locations 130a-130n of FIG. 1, or the like) at which a first network service (e.g., one of network services 134a-134z of FIG. 1, or the like) is being provisioned. At operation 510, the computing system may present the one or more topics of interest to a requesting device (e.g., requesting device(s) 140 of FIG. 1, or the like) via a first UI (e.g., UI 142 of FIG. 1, or the like). In examples, predicting the one or more topics of interest (at operation 505) and presenting the one or more topics of interest (at operation 510) may be performed concurrent with or prior to receiving a first input from the requesting device via the first UI.

In examples, the one or more topics of interest are predicted using a predictive AI model (e.g., an prediction model 154 of the AI prediction system 152 of FIG. 1, or the like) based on at least one of a first ID associated with the first end-user, a second ID associated with the premises location, a third ID associated with the first network service, a history of requests from the first end-user, a history of queries from the first end-user, a history of complaints from the first end-user, current incident reports associated with a geographical location within which the premises location is located, historical incident reports associated with the geographical location within which the premises location is located, current incident reports associated with a type of network service corresponding to the first network service, historical incident reports associated with the type of network service corresponding to the first network service, current incident reports associated with a type of network equipment used for provisioning the first network service, historical incident reports associated with the type of network equipment used for provisioning the first network service, or a history of service requests associated with one or more of the first ID, the second ID, or the third ID, and/or the like.

At operation 515, the computing system may generate one or more prompts for an LLM (e.g., LLM 112 of AI system 110 of FIG. 1, or the like) to query a vector data storage device (e.g., vector data storage device 114 of FIG. 1, or the like), based on the one or more topics. At operation 520, the computing system may receive, from the requesting device via the first UI, a selection of a first topic of interest among the one or more topics of interest (e.g., request 144 of FIG. 1, or the like). At operation 525, the computing system may send a first prompt among the one or more prompts to the LLM, the first prompt corresponding to the first topic of interest. At operation 530, the computing system may receive an output from the LLM. At operation 535, the computing system may determine a content of the output from the LLM. If information is found, then method 500 may continue onto the process at operation 540. If information is not found, then method 500 may continue onto the process at operation 545.

At operation 540, based on a determination that the output from the LLM includes a first output including data associated with the first topic of interest, the computing system may present the first output (e.g., data 148 of FIG. 1, or the like) to the requesting device. In some cases, the first output being generated by the LLM based on knowledge base data (e.g., vectorized data 120 among vectorized data 120a-120y of FIG. 1, or the like), which has been accessed from a set of databases (e.g., knowledge database(s) 118a and/or 118b of FIG. 1, or the like), that has been retrieved, divided, and vectorized by the vector data storage device. Method 500 may continue onto the process at operation 555 in FIG. 5B, following the circular marker denoted, "A."

At operation 545, based on a determination that the output from the LLM includes a first message indicating that the vector data storage device was unable to find data associated with the first topic of interest within the set of databases, the computing system may generate a first incident report that initiates a first investigation into the first topic of interest in response to receiving the first message. At operation 550, the computing system may generate and present a second message (e.g., data 148 of FIG. 1, or the like) to the requesting device, the second message indicating that the first topic of interest is being investigated. Method 500 may continue onto the process at operation 570 in FIG. 5C, following the circular marker denoted, "B."

In some examples, the set of databases may contain a plurality of documents, a plurality of case flow diagrams, a plurality of queries, a plurality of websites, or data collected by a CRM system, and/or the like. In some cases, the plurality of documents may be associated with a plurality of network services provisioned by the service provider. In some instances, the plurality of documents may include one or more documents associated with addressing one or more network issues associated with one or more of the plurality of network services. In some examples, the plurality of case flow diagrams may each be associated with addressing a network issue among a plurality of network issues. In examples, the plurality of queries may include queries associated with network services, queries associated with network issues associated with network services, and queries associated with addressing the network issues, and/or the like. In some cases, the plurality of websites may include websites associated with network services, websites associated with network issues associated with network services, and websites associated with addressing the network issues, and/or the like. In some instances, the data collected by the CRM system may include customer data associated with a plurality of customers of the service provider, service data associated with network services provisioned to the plurality of customers, and billing data associated with billing for the network services provisioned to the plurality of customers, and/or the like.

In examples, the vector data storage device may include a RAG data storage system that is a long-term, persisting, cache-like vector database. In some cases, the knowledge base data may include vector representations of portions of textual data, message data, image data, audio data, video data, document data, or data files associated with the first network service that are contained in at least one of the plurality of documents, the plurality of case flow diagrams, the plurality of queries, the plurality of websites, or the data collected by the CRM system, and that are divided based on one or more of sentences, paragraphs, pages, documents, subject, topic, or relevance to the first network service.

At operation 555 in FIG. 5B (following the circular marker denoted, "A," in FIG. 5A), method 500 may include the computing system receiving feedback data (e.g., feedback data 150 of FIG. 1, or the like) regarding effectiveness of the data associated with addressing the first topic of interest. At operation 560, the computing system may send the feedback data to the set of databases for inclusion as part of documents associated with the first topic of interest that are stored in the set of databases. At operation 565, based on a determination that the feedback data includes information indicating that the data associated with addressing the first topic of interest is not effective, the computing system may generate a second incident report that initiates a second investigation into the first topic of interest.

At operation 570 in FIG. 5C (following the circular marker denoted, "B," in FIG. 5B), method 500 may include the computing system receiving, from a device associated with one of a service provider agent or a technician, at least one of one or more documents or one or more case flow diagrams associated with addressing the first topic of interest. In some examples, each document or case flow diagram may include information regarding effectiveness in terms of resolving the first topic of interest. At operation 575, the computing system may send the at least one of the one or more documents or the one or more case flow diagrams to the set of databases for inclusion as part of documents or case flow diagrams associated with the first topic of interest that are stored in the set of databases.

While the techniques and procedures in methods 400, 500 are depicted and/or described in a certain order for purposes of illustration, it should be appreciated that certain procedures may be reordered and/or omitted within the scope of various embodiments. Moreover, while the methods 400, 500 may be implemented by or with (and, in some cases, are described below with respect to) the systems, examples, or embodiments 100, 200A, 200B and 300 of FIGS. 1, 2A, 2B, and 3, respectively (or components thereof), such methods may also be implemented using any suitable hardware (or software) implementation. Similarly, while each of the systems, examples, or embodiments 100, 200A, 200B and 300 of FIGS. 1, 2A, 2B, and 3, respectively (or components thereof), can operate according to the methods 400, 500 (e.g., by executing instructions embodied on a computer readable medium), the systems, examples, or embodiments 100, 200A, 200B and 300 of FIGS. 1, 2A, 2B, and 3, can each also operate according to other modes of operation and/or perform other suitable procedures.

### Exemplary System and Hardware Implementation

FIG. 6 is a block diagram illustrating an exemplary computer or system hardware architecture, in accordance with various embodiments. FIG. 6 provides a schematic illustration of one embodiment of a computer system 600 of the service provider system hardware that can perform the methods provided by various other embodiments, as described herein, and/or can perform the functions of computer or hardware system (i.e., query management system 102, computing system 104, AI system 110, AI prediction system 152, access tools 122, CPE 126a-126n, monitoring system 136, and requesting device(s) 140, etc.), as described above. It should be noted that FIG. 6 is meant only to provide a generalized illustration of various components, of which one or more (or none) of each may be utilized as appropriate. FIG. 6, therefore, broadly illustrates how individual system elements may be implemented in a relatively separated or relatively more integrated manner.

The computer or hardware system 600 – which might represent an embodiment of the computer or hardware system (i.e., query management system 102, computing system 104, AI system 110, AI prediction system 152, access tools 122, CPE 126a-126n, monitoring system 136, and requesting device(s) 140, etc.), described above with respect to FIGS. 1-5C – is shown including hardware elements that can be electrically coupled via a bus 605 (or may otherwise be in communication, as appropriate). The hardware elements may include one or more processors 610, including, without limitation, one or more general-purpose processors and/or one or more special-purpose processors (such as microprocessors, digital signal processing chips, graphics acceleration processors, and/or the like); one or more input devices 615, which can include, without limitation, a mouse, a keyboard, and/or the like; and one or more output devices 620, which can include, without limitation, a display device, a printer, and/or the like.

The computer or hardware system 600 may further include (and/or be in communication with) one or more storage devices 625, which can include, without limitation, local and/or network accessible storage, and/or can include, without limitation, a disk drive, a drive array, an optical storage device, solid-state storage device such as a random access memory ("RAM") and/or a read-only memory ("ROM"), which can be programmable, flash-updateable, and/or the like. Such storage devices may be configured to implement any appropriate data stores, including, without limitation, various file systems, database structures, and/or the like.

The computer or hardware system 600 might also include a communications subsystem 630, which can include, without limitation, a modem, a network card (wireless or wired), an infra-red communication device, a wireless communication device and/or chipset (such as a Bluetooth™ device, an 802.11 device, a Wi-Fi device, a WiMAX device, a WWAN device, cellular communication facilities, etc.), and/or the like. The communications subsystem 630 may permit data to be exchanged with a network (such as the network described below, to name one example), with other computer or hardware systems, and/or with any other devices described herein. In many embodiments, the computer or hardware system 600 will further include a working memory 635, which can include a RAM or ROM device, as described above.

The computer or hardware system 600 also may include software elements, shown as being currently located within the working memory 635, including an operating system 640, device drivers, executable libraries, and/or other code, such as one or more application programs 645, which may include computer programs provided by various embodiments (including, without limitation, hypervisors, virtual machines ("VMs"), and the like), and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be encoded and/or stored on a non-transitory computer readable storage medium, such as the storage device(s) 625 described above. In some cases, the storage medium might be incorporated within a computer system, such as the system 600. In other embodiments, the storage medium might be separate from a computer system (i.e., a removable medium, such as a compact disc, etc.), and/or provided in an installation package, such that the storage medium can be used to program, configure, and/or adapt a general purpose computer with the instructions/code stored thereon. These instructions might take the form of executable code, which is executable by the computer or hardware system 600 and/or might take the form of source and/or installable code, which, upon compilation and/or installation on the computer or hardware system 600 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware (such as programmable logic controllers, field-programmable gate arrays, application-specific integrated circuits, and/or the like) might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer or hardware system (such as the computer or hardware system 600) to perform methods in accordance with various embodiments of the invention. According to a set of embodiments, some or all of the procedures of such methods are performed by the computer or hardware system 600 in response to processor 610 executing one or more sequences of one or more instructions (which might be incorporated into the operating system 640 and/or other code, such as an application program 645) contained in the working memory 635. Such instructions may be read into the working memory 635 from another computer readable medium, such as one or more of the storage device(s) 625. Merely by way of example, execution of the sequences of instructions contained in the working memory 635 might cause the processor(s) 610 to perform one or more procedures of the methods described herein.

The terms "machine readable medium" and "computer readable medium," as used herein, refer to any medium that participates in providing data that causes a machine to operate in a specific fashion. In an embodiment implemented using the computer or hardware system 600, various computer readable media might be involved in providing instructions/code to processor(s) 610 for execution and/or might be used to store and/or carry such instructions/code (e.g., as signals). In many implementations, a computer readable medium is a non-transitory, physical, and/or tangible storage medium. In some embodiments, a computer readable medium may take many forms, including, but not limited to, non-volatile media, volatile media, or the like. Non-volatile media includes, for example, optical and/or magnetic disks, such as the storage device(s) 625. Volatile media includes, without limitation, dynamic memory, such as the working memory 635. In some alternative embodiments, a computer readable medium may take the form of transmission media, which includes, without limitation, coaxial cables, copper wire, and fiber optics, including the wires that include the bus 605, as well as the various components of the communication subsystem 630 (and/or the media by which the communications subsystem 630 provides communication with other devices). In an alternative set of embodiments, transmission media can also take the form of waves (including without limitation radio, acoustic, and/or light waves, such as those generated during radio-wave and infra-red data communications).

Common forms of physical and/or tangible computer readable media include, for example, a floppy disk, a flexible disk, a hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 610 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer or hardware system 600. These signals, which might be in the form of electromagnetic signals, acoustic signals, optical signals, and/or the like, are all examples of carrier waves on which instructions can be encoded, in accordance with various embodiments of the invention.

The communications subsystem 630 (and/or components thereof) generally will receive the signals, and the bus 605 then might carry the signals (and/or the data, instructions, etc. carried by the signals) to the working memory 635, from which the processor(s) 605 retrieves and executes the instructions. The instructions received by the working memory 635 may optionally be stored on a storage device 625 either before or after execution by the processor(s) 610.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A method, comprising:
receiving, by a computing system and from a requesting device, a first request for information regarding a first issue associated with a first network service that is provisioned, by a service provider, at a premises location;
generating, by the computing system, a first prompt for a large language model ("LLM") to query a vector data storage device for the information regarding the first issue from a set of databases;
sending, by the computing system, the first prompt to the LLM;
receiving, by the computing system, an output from the LLM;
determining, by the computing system, a content of the output from the LLM;
based on a determination that the output from the LLM includes a first output including data associated with the first issue, presenting, by the computing system, the first output to the requesting device; and
based on a determination that the output from the LLM includes a first message indicating that the vector data storage device was unable to find data associated with the first issue within the set of databases, performing the following:
generating, by the computing system, a first incident report that initiates a first investigation into the first issue in response to receiving the first message; and
generating and presenting, by the computing system, a second message to the requesting device, the second message indicating that the first issue is being investigated.

2. The method of claim 1, wherein the first output includes a summary of data associated with addressing the first issue.

3. The method of claim 2, further comprising:
receiving, by the computing system, feedback data regarding effectiveness of the data associated with addressing the first issue;
sending, by the computing system, the feedback data to the set of databases for inclusion as part of documents associated with the first issue that are stored in the set of databases; and
based on a determination that the feedback data includes information indicating that the data associated with addressing the first issue is not effective, generating, by the computing system, a second incident report that initiates a second investigation into the first issue.

4. The method of claim 1, further comprising:
receiving, by the computing system, at least one of one or more documents or one or more case flow diagrams associated with addressing the first issue, each document or case flow diagram including information regarding effectiveness in terms of resolving the first issue; and
sending, by the computing system, the at least one of the one or more documents or the one or more case flow diagrams to the set of databases for inclusion as part of documents or case flow diagrams associated with the first issue that are stored in the set of databases.

5. The method of claim 1, wherein receiving the first request and presenting the first output or the second message are implemented using at least one of a user interface ("UI"), a portal, a software application, or an application programming interface ("API").

6. The method of claim 1, wherein the first request is received via a first UI, wherein the method further comprises:
prior to or as the first request is being entered via the first UI, predicting, by the computing system, one or more topics of interest to a first end-user associated with the premises location at which the first network service is being provisioned;
presenting, by the computing system, the one or more topics of interest to the requesting device via the first UI; and
generating, by the computing system, one or more prompts for the LLM to query the vector data storage device, based on the one or more topics of interest.

7. The method of claim 6, wherein the one or more topics of interest are predicted using a predictive artificial intelligence ("AI") model based on at least one of a first identifier ("ID") associated with the first end-user, a second ID associated with the premises location, a third ID associated with the first network service, a history of requests from the first end-user, a history of queries from the first end-user, a history of complaints from the first end-user, current incident reports associated with a geographical location within which the premises location is located, historical incident reports associated with the geographical location within which the premises location is located, current incident reports associated with a type of network service corresponding to the first network service, historical incident reports associated with the type of network service corresponding to the first network service, current incident reports associated with a type of network equipment used for provisioning the first network service, historical incident reports associated with the type of network equipment used for provisioning the first network service, or a history of service requests associated with one or more of the first ID, the second ID, or the third ID.

8. The method of claim 1, wherein the set of databases contains a plurality of documents, a plurality of case flow diagrams, a plurality of queries, a plurality of websites, or data collected by a customer relationship management ("CRM") system, wherein the plurality of documents is associated with a plurality of network services provisioned by the service provider, the plurality of documents including one or more documents associated with addressing one or more network issues associated with one or more of the plurality of network services, wherein the plurality of case flow diagrams is each associated with addressing a network issue among a plurality of network issues, wherein the plurality of queries includes queries associated with network services, queries associated with network issues associated with network services, and queries associated with addressing the network issues, wherein the plurality of websites includes websites associated with network services, websites associated with network issues associated with network services, and websites associated with addressing the network issues, wherein the data collected by the CRM system includes customer data associated with a plurality of customers of the service provider, service data associated with network services provisioned to the plurality of customers, and billing data associated with billing for the network services provisioned to the plurality of customers.

9. The method of claim 8, wherein the first output being generated by the LLM based on knowledge base data, which has been accessed from the set of databases, that has been retrieved, divided, and vectorized by the vector data storage device.

10. The method of claim 9, wherein the vector data storage device includes a retrieval augmented generation ("RAG") data storage system that is a long-term, persisting, cache-like vector database, wherein the knowledge base data includes vector representations of portions of textual data, message data, image data, audio data, video data, document data, or data files associated with the first network service that are contained in at least one of the plurality of documents, the plurality of case flow diagrams, the plurality of queries, the plurality of websites, or the data collected by CRM system, and that are divided based on one or more of sentences, paragraphs, pages, documents, subject, topic, or relevance to the first network service.

11. The method of claim 1, wherein generating the first prompt for the LLM to query the vector data storage device includes generating a second prompt for the LLM to query an index table for the vector data storage device for at least one of a first index reference associated with the first network service or a second index reference associated with the first issue.

12. A system, comprising:
a processing system; and
memory coupled to the processing system, the memory comprising computer executable instructions that, when executed by the processing system, causes the system to perform operations comprising:
receiving, from a requesting device, a first request for information regarding a first issue associated with a first network service that is provisioned, by a service provider, at a premises location;
generating a first prompt for a large language model ("LLM") to query a vector data storage device for the information regarding the first issue from a set of databases;
sending the first prompt to the LLM;
receiving an output from the LLM;
determining a content of the output from the LLM;
based on a determination that the output from the LLM includes a first output including data associated with the first issue, presenting the first output to the requesting device; and
based on a determination that the output from the LLM includes a first message indicating that the vector data storage device was unable to find data associated with the first issue within the set of databases, performing the following:
generating a first incident report that initiates a first investigation into the first issue in response to receiving the first message; and
generating and presenting a second message to the requesting device, the second message indicating that the first issue is being investigated.

13. The system of claim 12, wherein the first output includes a summary of data associated with addressing the first issue.

14. The system of claim 12, wherein receiving the first request and presenting the first output or the second message are implemented using at least one of a user interface ("UI"), a portal, a software application, or an application programming interface ("API").

15. The system of claim 12, wherein the set of databases contains a plurality of documents, a plurality of case flow diagrams, a plurality of queries, a plurality of websites, or data collected by a customer relationship management ("CRM") system, wherein the plurality of documents is associated with a plurality of network services provisioned by the service provider, the plurality of documents including one or more documents associated with addressing one or more network issues associated with one or more of the plurality of network services, wherein the plurality of case flow diagrams is each associated with addressing a network issue among a plurality of network issues, wherein the plurality of queries includes queries associated with network services, queries associated with network issues associated with network services, and queries associated with addressing the network issues, wherein the plurality of websites includes websites associated with network services, websites associated with network issues associated with network services, and websites associated with addressing the network issues, wherein the data collected by the CRM system includes customer data associated with a plurality of customers of the service provider, service data associated with network services provisioned to the plurality of customers, and billing data associated with billing for the network services provisioned to the plurality of customers.

16. The system of claim 15, wherein the first output being generated by the LLM based on knowledge base data, which has been accessed from the set of databases, that has been retrieved, divided, and vectorized by the vector data storage device.

17. The system of claim 16, wherein the vector data storage device includes a retrieval augmented generation ("RAG") data storage system that is a long-term, persisting, cache-like vector database, wherein the knowledge base data includes vector representations of portions of textual data, message data, image data, audio data, video data, document data, or data files associated with the first network service that are contained in at least one of the plurality of documents, the plurality of case flow diagrams, the plurality of queries, the plurality of websites, or the data collected by CRM system, and that are divided based on one or more of sentences, paragraphs, pages, documents, subject, topic, or relevance to the first network service.

18. A method, comprising:
concurrent with or prior to receiving a first input from a requesting device via a first user interface ("UI"), predicting, by a computing system, one or more topics of interest to a first end-user associated with a premises location at which a first network service is being provisioned;
presenting, by the computing system, the one or more topics of interest to the requesting device via the first UI;
generating, by the computing system, one or more prompts for a large language model ("LLM") to query a vector data storage device, based on the one or more topics;
receiving, by the computing system and from the requesting device via the first UI, a selection of a first topic of interest among the one or more topics of interest;
sending, by the computing system, a first prompt among the one or more prompts to the LLM, the first prompt corresponding to the first topic of interest;
receiving, by the computing system, an output from the LLM;
determining, by the computing system, a content of the output from the LLM;
based on a determination that the output from the LLM includes a first output including data associated with the first topic of interest, presenting, by the computing system, the first output to the requesting device; and
based on a determination that the output from the LLM includes a first message indicating that the vector data storage device was unable to find data associated with the first topic of interest within the set of databases, performing the following:
generating, by the computing system, a first incident report that initiates a first investigation into the first topic of interest in response to receiving the first message; and
generating and presenting, by the computing system, a second message to the requesting device, the second message indicating that the first topic of interest is being investigated.

19. The method of claim 18, wherein the one or more topics of interest are predicted using a predictive artificial intelligence ("AI") model based on at least one of a first identifier ("ID") associated with the first end-user, a second ID associated with the premises location, a third ID associated with the first network service, a history of requests from the first end-user, a history of queries from the first end-user, a history of complaints from the first end-user, current incident reports associated with a geographical location within which the premises location is located, historical incident reports associated with the geographical location within which the premises location is located, current incident reports associated with a type of network service corresponding to the first network service, historical incident reports associated with the type of network service corresponding to the first network service, current incident reports associated with a type of network equipment used for provisioning the first network service, historical incident reports associated with the type of network equipment used for provisioning the first network service, or a history of service requests associated with one or more of the first ID, the second ID, or the third ID.

20. The method of claim 18, further comprising:
receiving, by the computing system, feedback data regarding effectiveness of the data associated with addressing the first topic of interest;
sending, by the computing system, the feedback data to the set of databases for inclusion as part of documents associated with the first topic of interest that are stored in the set of databases; and
based on a determination that the feedback data includes information indicating that the data associated with addressing the first topic of interest is not effective, generating, by the computing system, a second incident report that initiates a second investigation into the first topic of interest.
